(19) United States
(12) Patent Application Publication
(10) Pub. No.: US 2003/0209438 A1
(43) Pub. Date: Nov. 13, 2003

(54) Particle characterization using gravity in opposition to an induced force

(76) Inventor: Vincent Bressler, Menlo Park, CA (US)

Correspondence Address: Vincent Bressler, 240 East Creek Drive, Menlo Park, CA, 94025, US

(21) Appl. No.: 10/142,084

(22) Filed: May 9, 2002

(51) Int. Cl. G01N 27/26; G01N 27/447; G01H 17/00

(52) U.S. Cl. 204/547; 204/643; 73/570.5

(57) ABSTRACT

A method and apparatus are disclosed which precisely characterizes the physical properties of particles (20) (21). The apparatus balances the force of gravity (22) (23) against an induced upward force (24) (25) and measures the elevation (27) (28) of suspended particles. The upward force is generated by a structure (26) containing elements and signals that repel the particles.

### REFERENCES CITED

U.S. Pat. Documents

| | | | |
|---|---|---|---|
| 6,264,815 | January 1999 | Pethig | 204/547 |
| 5,344,535 | April 1993 | Betts | 204/547 |
| 4,956,065 | November 1988 | Kaler | 204/547 |
| 4,326,934 | December 1979 | Pohl | 204/547 |

Federally Sponsored Research and Development

The invention was conceived and developed without aid of any government sponsorship.

### BACKGROUND OF THE INVENTION

1. Field of the Invention

This invention relates to the characterization of the physical properties of particles.

2. Prior art

A particle is a discrete structure that responds as one entity. Particles may be molecules, biological cells, or larger structures. Characterization is an indirect method of gathering information about the physical structure or state of particles. To characterize a particle it is necessary to first alter the environment around the particle and second, measure the change to the particle. Depending on its physical structure or state, each particle will respond differently to the same environmental change. Characterization is the process of measuring different responses.

One method for characterizing particles is dielectrophoresis. To perform characterization via dielectrophoresis, first induce an appropriate electrical field around the particles using an electrode structure and signal generator, then measure the force exerted on the particles by that field. The strength of the force depends on the size, electrical and structural properties of the particle, the electrical properties of the fluid, the amplitude, frequency, and structure of the applied electric field. Characterization may involve variation of the amplitude, frequency, or structure of the electric field. Likewise, characterization may involve variation of the electrical properties of the fluid containing the particles being characterized.

Dielectrophoresis characterizes living cells without harming the cells. Such characterization can measure the condition of living cells, and can be used to identify different types of cells. Additionally characterization informs the selection of signal frequencies, amplitudes, and fluid conductivity that may be used to separate particles of different types.

U.S. Pat. No. 6,264,815 to Pethig et al. (1999) describes a method to characterize particles using dielectrophoresis. With that method particles are attracted to various locations on an array of electrodes. This approach has several drawbacks. First, it requires the generation and distribution of a variety of electrical signals. Second, the characterization data derived is granular because the apparatus requires separate signal paths for each gradation in the measurement. Third, particles must cross paths in order to find the attracting electrode. While in transit, many particles are blocked or diverted. Fourth, particles must be detected while they adhere to electrodes. This is difficult to do since the electrodes tend to obscure the particles. Fifth, particles must always come into physical contact with electrodes in order to be characterized. This may damage particles.

U.S. Pat. No. 5,344,535 to Betts et al. (1993) describes a method for characterizing particles as they move over an electrode surface via bulk fluid flow. The dielectrophoretic force from a set of electrodes traps particles. This method has many of the drawbacks of the previously cited patent and additional problems. First, the chamber must be low, restricting cells to the space just above the electrodes. This increases the opportunity for cells collide with one another or with the electrodes. Such collisions may damage cells and provide opportunity for cells to become stranded, thereby disrupting the measurement. Second, the fluid flow must be fast enough to move the cells along, but not so fast as to prevent cells from adhering.

U.S. Pat. No. 4,956,065 to Kaler, et al. (1988) describes a method for levitating a single cell using an active feedback mechanism. This method may only process one cell at a time for each set of control electronics and processor. Also, precise initial positioning of the cell is required.

U.S. Pat. No. 4,326,934 to Pohl (1979) describes a method for characterizing particles where the particles flow past a set of electrodes that redirect their path. This method has the following drawbacks. First, the method processes only one cell at a time for each set of control electronics and processor. Second, only a single frequency and amplitude may be used for each pass. Third, the measurement is granular because each gradation of the measurement requires independent electrode and signal pathways.

### SUMMARY OF THE INVENTION

The present invention is an apparatus and method that provides a force to levitate particles in balance with gravity and to determine the height of the particles.

### OBJECTS AND ADVANTAGES OF THE INVENTION

The invention requires minimal effort to incorporate into a system, yet provides precise particle characterization. Only one pair of electrical connections and only one electrical signal are required. The granularity of the measurement is limited only by the ability to resolve the height of each particle. Particles are not made to travel across electrodes or to cross paths as part of this measurement process. This reduces the possibility of measurement error caused by particle to particle interactions. Unlike previous methods, the characterization measurement is made while particles remain suspended in fluid at all times, preventing damage to the particles. Other methods require that particles be counted while they are in contact with opaque electrodes. Such counts are difficult to perform and prone to error. Further objects and advantages of the invention will become apparent from an inspection of the ensuing drawings and description.

### DESCRIPTIONS OF DRAWINGS

FIG. 1 is a description of the method of the invention.

FIG. 2 is a schematic drawing of the apparatus for the preferred embodiment of the invention.

FIG. 3 is a plan drawing of the electrode for the preferred embodiment of the invention.

FIG. 4 is a cross sectional view of the structure of the electrode for the preferred embodiment of the invention.

FIG. 5 is an explanation of the meaning of focus height.

FIG. 6 is an explanation of the focus height algorithm used for the preferred embodiment of the invention.

FIG. 7 is series of images of a yeast cell to illustrate the focus height algorithm.

FIG. 8 is a chart that shows the relative height of a population of yeast cells.

FIG. 9 is a flowchart that explains the algorithm to capture images.

FIG. 10 is a flowchart that explains the algorithm to convert images of particles to particle heights.

FIG. 11 shows an embodiment of the invention where the electrode is a set of parallel wires.

FIG. 12 shows and embodiment of the invention that includes a mesh of crossing wires.

FIG. 13 shows an embodiment of the invention that includes an array of vibration elements.

FIG. 14 shows an embodiment of the invention that includes multiple signal generators driving the electrodes. This figure also shows alternate electrode configurations.

FIG. 15 shows various types of signals that may be applied to the electrodes.

FIG. 16 shows an alternate embodiment of the invention using collimated light and a side mounted detector.

FIG. 17 shows an alternate embodiment of the invention where the particles are pushed up by electrodes underneath them and pushed down by electrodes on top.

FIG. 18 is an explanation of the balance of horizontal and vertical forces on a particle.

### DESCRIPTION OF REFERENCE NUMBERS

20—Suspended particle with relatively weak dielectrophoretic response

21—Suspended particle with relatively strong dielectrophoretic response

22—Gravitational force acting on particle with relatively weak dielectrophoretic response

23—Gravitational force acting on particle with relatively strong dielectrophoretic response

24—Net dielectrophoretic force acting on particle with relatively weak dielectrophoretic response

25—Net dielectrophoretic force acting on particle with relatively strong dielectrophoretic response

26—Source of electric fields that induce a dielectrophoretic response

27—Relative height of suspended particle with relatively weak dielectrophoretic response when the net dielectrophoretic force is in balance with the gravitational force

28—Relative height of suspended particle with relatively strong dielectrophoretic response when the net dielectrophoretic force is in balance with the gravitational force

30—Suspended in particle in fluid filled chamber

32—Electrode

34—Fluid filled chamber

36—Glass substrate upon which the electrode is fabricated

38—Side-wall of fluid filled chamber

40—Glass cover over the top of the fluid filled chamber

42—Microscope body

44—Microscope lens

46—Video camera

48—Computer

50—Electrical signal generation electronics

52—Light source for the microscope

54—Driver electronics for the stepper motor

56—Stepper motor

58—Drive belt that connects the stepper motor to the focus knob on the microscope

60—Focus knob on the microscope

62—Electrode to which ground is applied

63—Spacing between electrodes

64—Electrode to which electrical signal is applied

65—Width of an electrode

66—Solder connection between signal generator and electrical signal electrode

68—Solder connection between signal generator and ground electrode

70—Chrome adhesion layer of electrode between gold and glass

72—Gold primary conductive layer of electrode

74—Distance between base of object lens housing and focal plane for the microscope

75—Distance between the focal plane and the substrate

76—One ray of light passing through the particle, the microscope lens system and arriving at the video detector

78—The focal plane for the microscope

80—The video detector

82—Mechanical link between microscope optics and video detector

84—Ray of light passing through a particle suspended above the focal plane

86—Ray of light passing through a particle suspended at the focal plane

88—Ray of light passing through a particle suspended below the focal plane

90—Particle suspended below the focal plane

92—Particle suspended above the focal plane

94—Image of particle suspended above the focal plane

96—Image of particle suspended at the focal plane

98—Image of particle suspended below the focal plane

100—Processed image of particle suspended above the focal plane

102—Processed image of particle suspended at the focal plane

104—Processed image of particle suspended below the focal plane

106—Elevation vs. intensity coordinate of particle suspended above the focal plane

108—Elevation vs. intensity coordinate of particle suspended at the focal plane

110—Elevation vs. intensity coordinate of particle suspended below the focal plane

112—Line fit using three intensity/elevation points for one particle

114—Computed elevation of the particle

120—Parallel wire electrode

130—Wire mesh electrode

132—Grounding of wire mesh electrode

134—Base plate for wire mesh electrode embodiment

136—Connection of signal to base plate for the wire mesh electrode embodiment of the invention

150—Vibration element for the embodiment of the invention that uses pressure waves to elevate particles

152—Signal connection to vibration element

153—Ground connection to vibration element

160—Signal generator to drive right-side electrode

162—Signal generator to drive left-side electrode

164—Connection between signal generator and left side electrode

168—Connection between signal generator and right side electrode

170—Right side electrode

172—Left side electrode

178—Alternate embodiment of parallel electrode tips

179—Another alternate embodiment of parallel electrode tips

180—Sine wave signal

182—Signal that is the sum of two sine waves

184—Signal that alternates between one sine wave and another sine wave

190—Collimated light used to illuminate particles in alternate embodiment of the invention

192—Source of collimated light

194—Highly conductive plate that may be used for signal distribution to the chamber for an alternate embodiment of the invention

196—Channel etched or cut into the highly conductive plate in order to create electric field in the chamber when the signal is applied to the conductive plate

197—Top substrate for alternate embodiment of the invention

198—Top electrodes for alternate embodiment of the invention

199—Distance between the top and bottom substrates for an alternate embodiment of the invention

200—The force of gravity acting on a particle

202—Net upward force exerted by the bottom electrodes on a particle

204—Net force exerted from the nearest right side electrode on a particle

206—Net force exerted from the nearest left side electrode on a particle

208—Force profile seen by gravity acting on a particle for a particular signal setting

### STRUCTURAL DESCRIPTION OF THE INVENTION

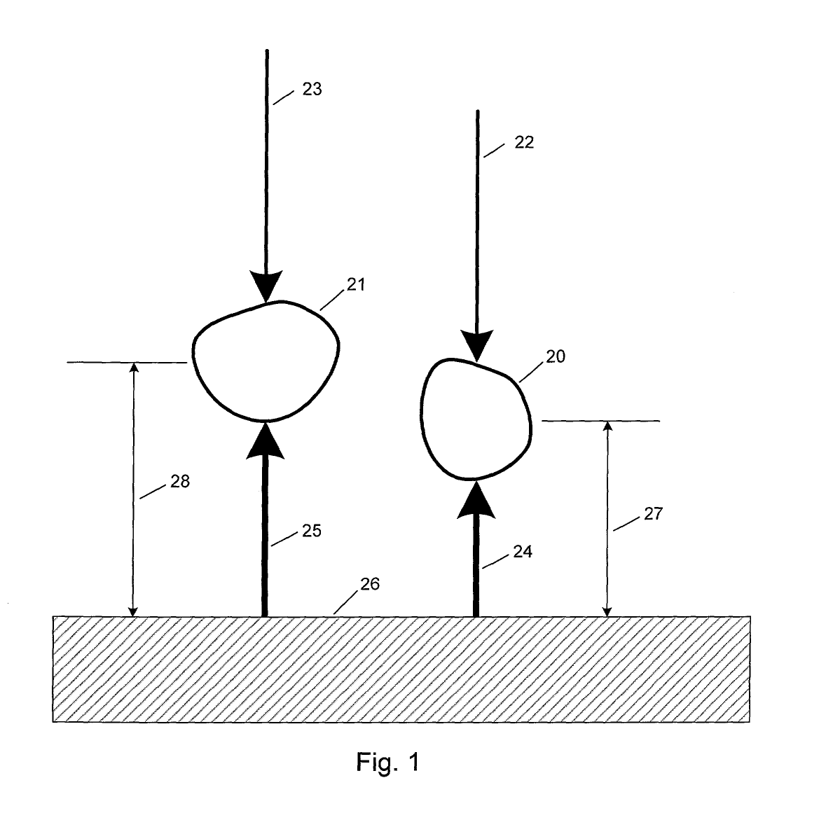

FIG. 1 illustrates the method of the invention. A structure 26 generates an electric field around particles 20 and 21. The electric field is time varying and its amplitude changes as the distance away from its source 26 increases. The electric field produces a net upward dielectrophoretic force, 25 and 24, on particles 20 and 21. The upward force balances the gravitational force on each particle, 22 and 23. Differences in the dielectrophoretic response of particles 20 and 21 may be detected as differences in the height, 27 and 28, of these particles above the signal source 26.

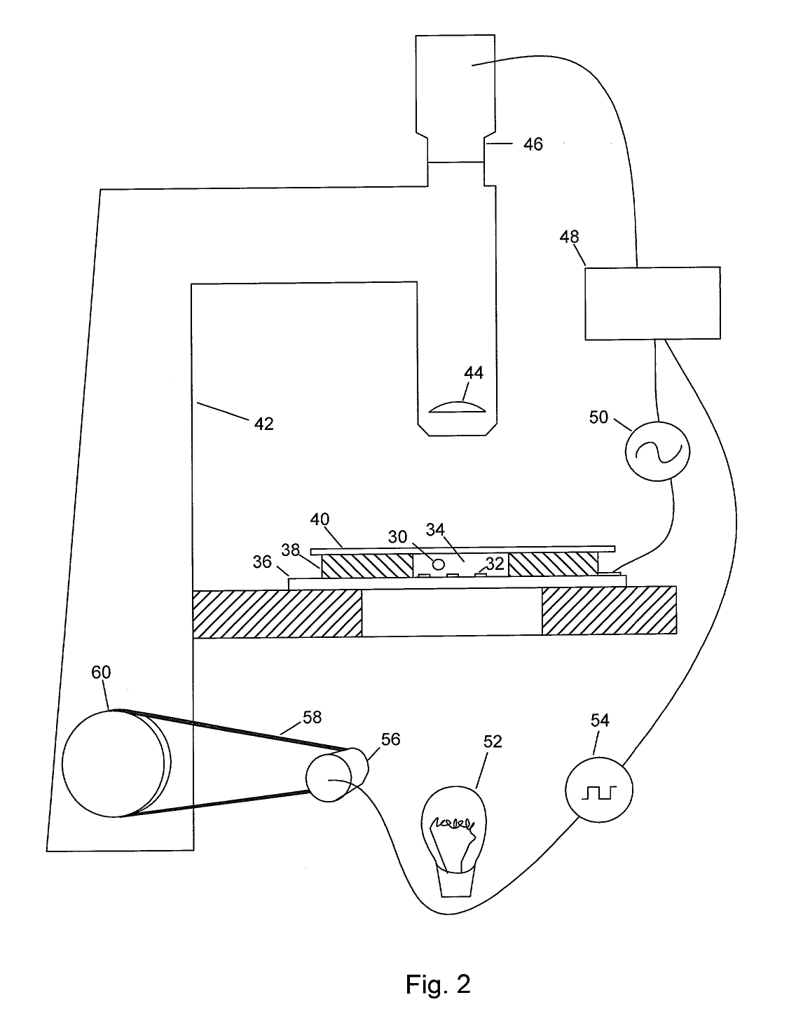

FIG. 2 shows the preferred embodiment of the invention. A population of particles of which the particle 30, is a single member, is suspended above a set of conductive electrodes 32 in a fluid filled chamber 34. The electrodes are attached to a glass substrate 36, and the fluid filled chamber walls outside of the electrode area are made of plastic. The height of the chamber is several times the typical diameter of a particle. A glass cover 40 seals the top of the chamber. The glass substrate rests on the sample holding area of a microscope 42. The microscope's illumination source 52 shines light up through the glass substrate, past the gaps between the electrodes, through the particles in the chamber, through the glass cover over the chamber, through the optical system of the microscope 42 and onto the detector of a video camera 46. A computer 48 receives image data from the video camera and stores these images to its hard disk or memory for later processing. The computer 48 is a conventional personal computer. The computer connects to the video camera using a standard interface, such as IEEE1394. The computer controls a standard signal source 50 that supplies an electrical signal to the electrodes. The signal source provides a 2 volt peak to peak signal with 50 ohms output impedance. This electrical signal creates electric fields in the chamber. The computer also controls a conventional stepper motor driver 54 that sends signals to a stepper motor 56 that drives a belt 58 that turns the fine focus knob on the microscope 60. By changing the focus height of the microscope optics 44 and camera 46 above the particles, the image of the particles will change. By analyzing these images, the height of each particle is determined.

The stepper motor 56 has a gear reduction attached to it. This provides for several thousand steps per revolution of the motor shaft. A small hub gear is attached to the shaft of the motor to contact the drive belt 58.

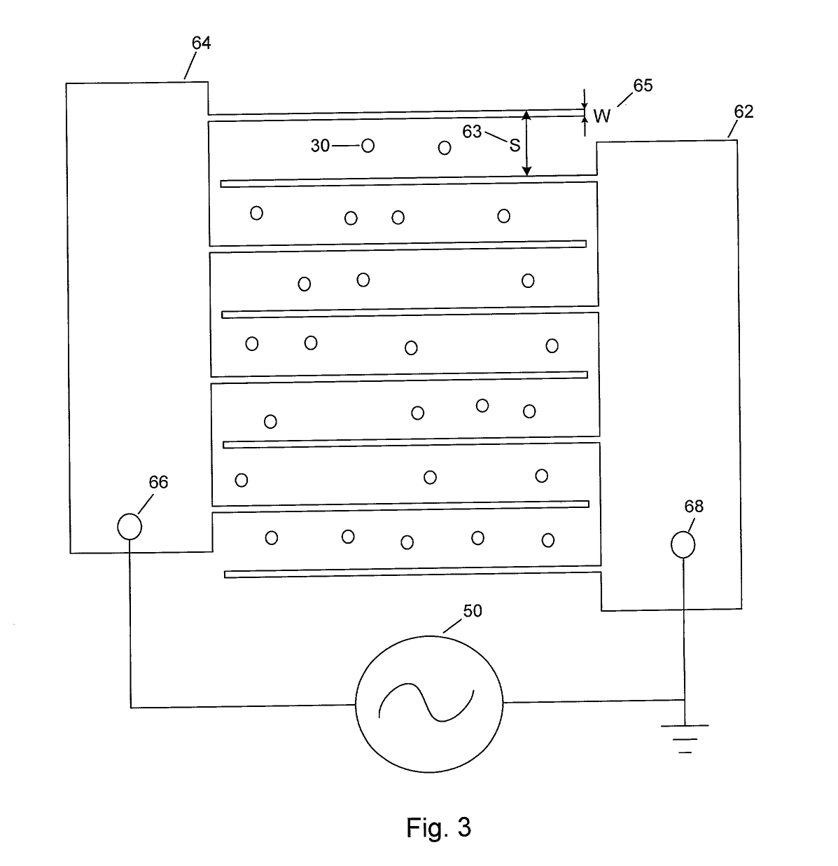

FIG. 3 is a plan view of the electrode geometry for the apparatus. There are two independent conductive surfaces. One of these 62 is grounded, and the other 64 receives a sinusoidal voltage with an amplitude of 2 volts and a frequency that may be anywhere from 1000 Hz to 10 MHz. Solder points 66 and 68 connect the signal generator 50 to the two electrodes. The width 65 of the finger-like electrode tips is 5 micro meters and the electrode spacing 63 is 50 micro meters. Particles 30 are repelled from the edges of the electrode tips and suspended between the electrode tips.

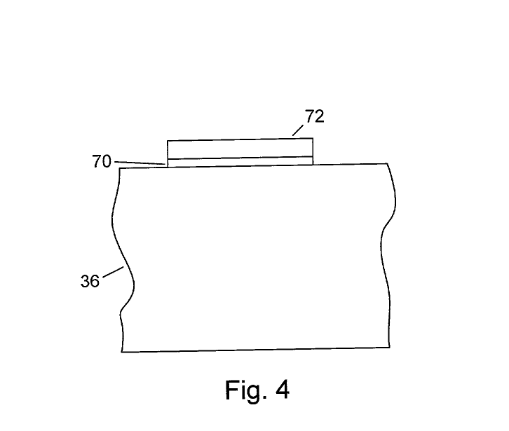

FIG. 4 is a cross section view of an electrode. The electrodes consist of a thin layer of chrome 70 with a thicker layer of gold on top 72. The chrome layer provides adhesion between the gold and the glass substrate 36. The gold layer is approximately 500 angstroms thick, and the chrome layer is approximately 100 angstroms thick. To fabricate the electrodes, follow these steps. First, clean the glass substrate with a hot solution of 30 percent hydrogen peroxide and 70 percent sulfuric acid. Second, deposit the metal layers using a metal sputtering system. Third, apply a layer of photoresist on the gold surface. Fourth, expose the photoresist using a patterned mask. Fifth, develop the photoresist using the standard procedure. Fifth, wet etch the metal layers using standard etchants for gold and chrome.

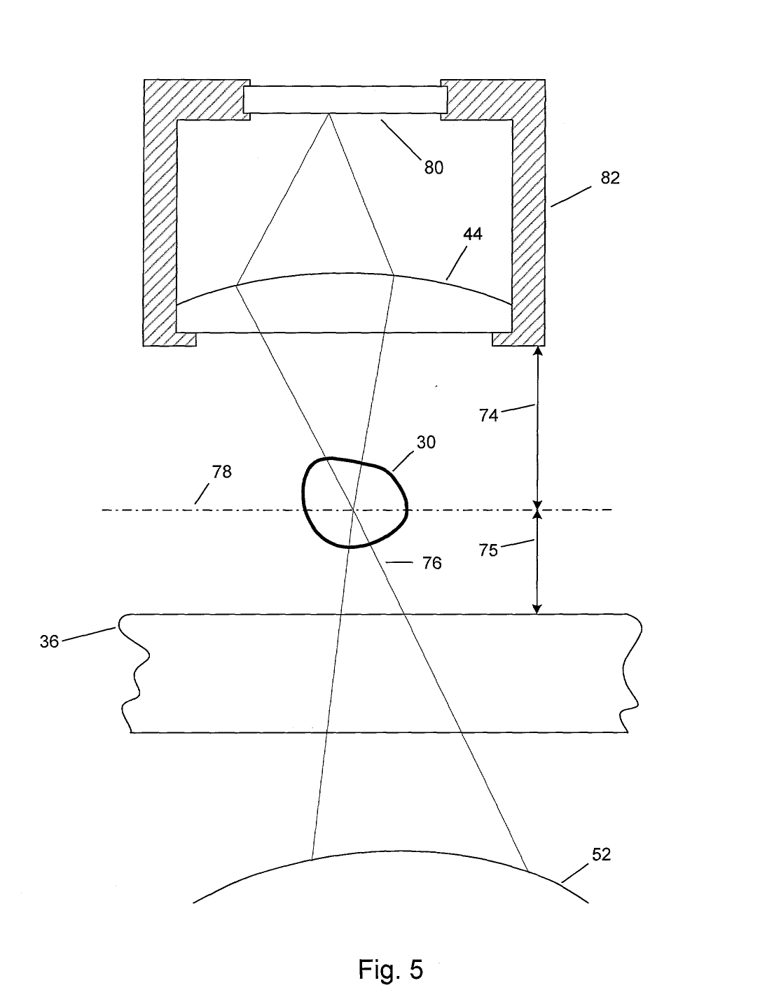

FIG. 5 shows the geometric relationship between parts of the apparatus and the particle 30 being measured. In this particular instance, all rays of light 76 pass through the center of the particle. Therefore, the particle's image is well focused on a video camera detector 80. The distance 72 from the focal plane 78, to the microscope objective 82, to the detector 80, is fixed. As such, the microscope focus knob, 60 from FIG. 2, adjusts the height 75 of the focal plane above the substrate 36.

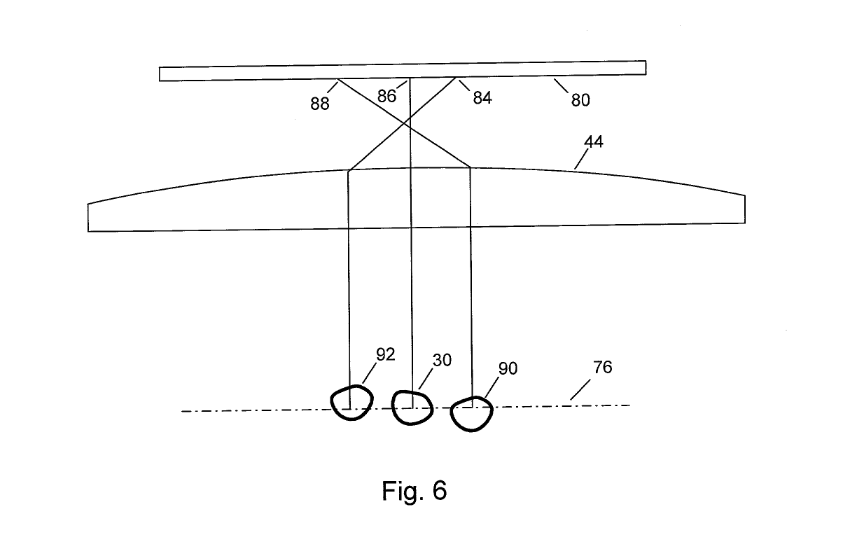

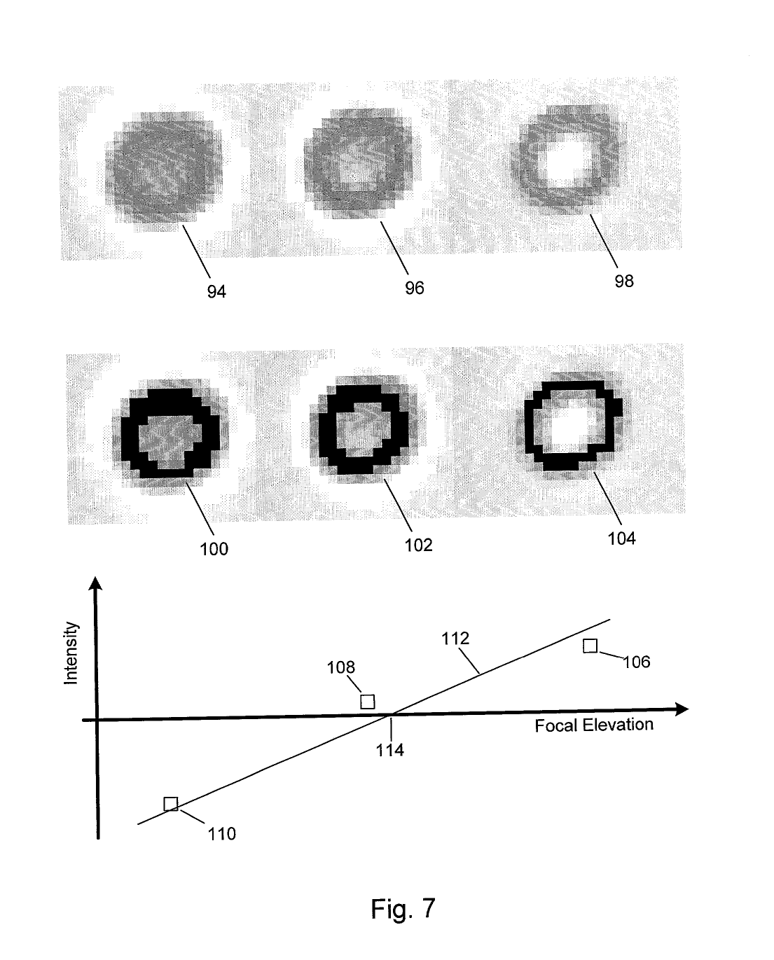

FIG. 6 shows three particles, one that is below the focal plane 90, one that is centered on the focal plane 30 and one 92 that is above the focal plane. After passing through the microscope lens system 44 the light from each of these particles falls on a different location on the detector 80. Images produced by particles 90, 30 and 92 are referenced as image number 88, 86, 84 respectively. These images are shown in FIG. 7.

At the top of FIG. 7 are the images produced by a single particle where the focal plane position, 75 from FIG. 6, relative to the particle is different for each image. For image 94 the particle is above the focal plane. For image 96 the particle is on the focal plane 96. For image 98 the particle is below the focal plane. The outer edge of each particle is located by looking for dark pixels in the image. Clusters of dark pixels that form circles of the correct size are identified as particles. Images 100, 102 and 104 are modified versions of the corresponding images 94, 96, 98, where the edge pixels for each particle have been marked black for identification. Once the edges of each particle image have been defined, determine the average light intensity inside the particle image by averaging the non-black pixel values inside of each black ring. Plot the inner particle intensity value 106, 108, 110 vs. the focus elevation of the microscope, and create a line fit 112 to these data points. Compute the intersection 114 of that line and a standard intensity value. The focal elevation at the intersection point is the relative elevation of the particle. The focal elevation is measured in motor step counts. The elevations of all particles in the image are measured with one focus elevation sweep.

### OPERATIONAL DESCRIPTION OF THE INVENTION

Particles must be suspended in a fluid with the proper characteristics. The general requirement is that the particles be in a fluid with different dielectric properties than the interior of the particle. When the particles are biological cells, it is sufficient to suspend the cells in a fluid with low electrical conductivity, on the order of 1000 uS/cm or less. When the cells are baker's yeast (Saccharomyces Cerevisiae), use the following procedure: Add de-ionized water to dried yeast in one beaker. Pipette about 5 ml of this high concentration activated yeast slurry into 400 ml of de-ionized water in another beaker. Then measure the conductivity, using a standard conductivity meter, of the diluted solution in the second beaker. A add small amounts of salt until the conductivity is on the order of 200 uS/cm. Place a drop of the 200 uS/cm fluid onto a microscope slide and place a cover slip on top of the drop. Adjust the microscope objective to 20×. If between 100 and 300 cells are visible in the field of view, then the diluted solution is ready. Otherwise, adjust the cell concentration of the dilute solution by adding water or by adding more of the high concentration yeast slurry. Adjust the conductivity by adding salt or water if necessary.

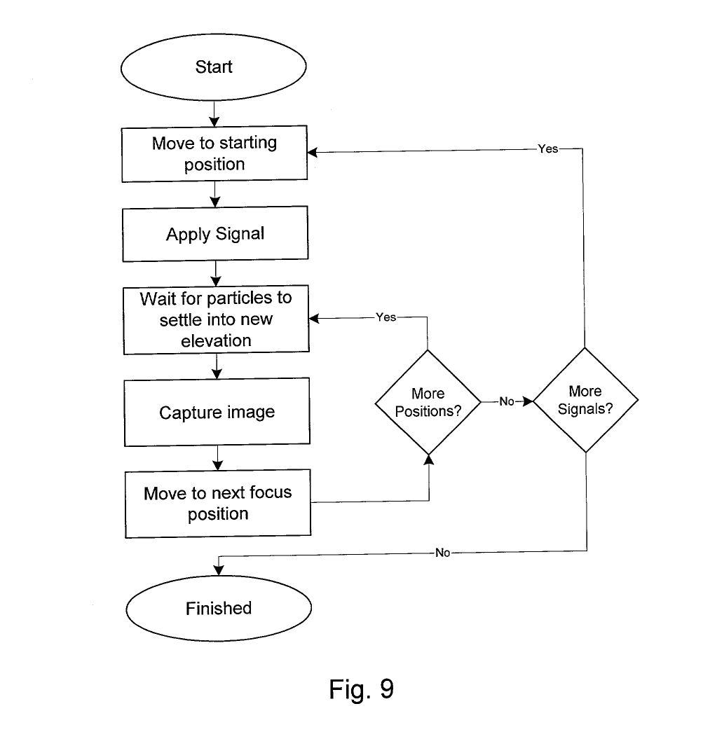

Once the dilute solution has been prepared, start using the instrument. Pipette a few drops of fluid into the fluid chamber 34. Place a cover glass 40 over the top of the chamber. Center the chamber over the microscope objective. Use 20× magnification and a video camera with 1024×768 pixels. A lower resolution camera may be used without modifying the imaging analysis technique. Once the cells are in place, allow settling time. Watch the video output to determine when the cells have stopped moving. Make sure that the focal height of the microscope is below all of the cells or above all of the cells. Focusing below all the cells is the best option since they are initially resting on the bottom of the chamber. Start a computer program, as flowcharted in FIG. 9. This program applies the a signal via the signal generator 50, waits about 20 seconds, captures an image from the video camera 46, moves to the next position using the motor 56 driven by the motor controller 54, captures another image and so on. The program captures a series of images at different focus elevations, commands the motor to return to the starting position, changes the signal to the electrodes, and collects a new series of images.

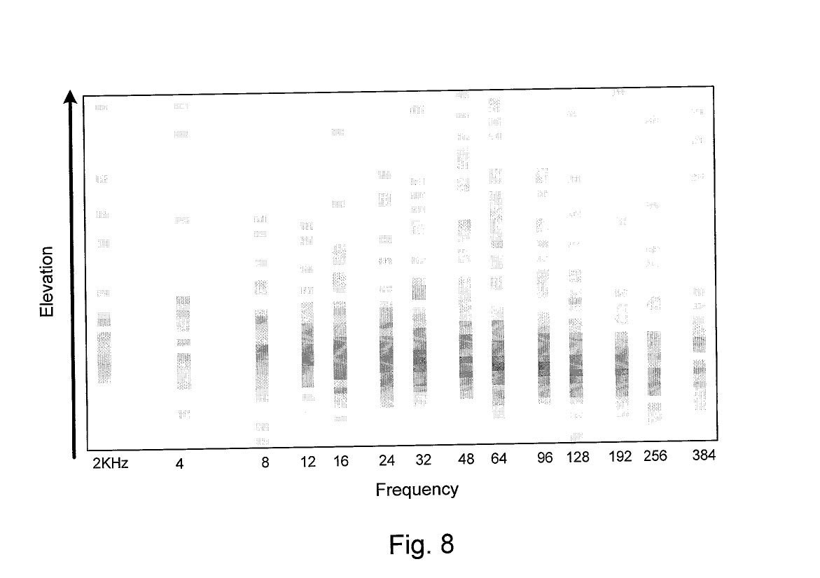

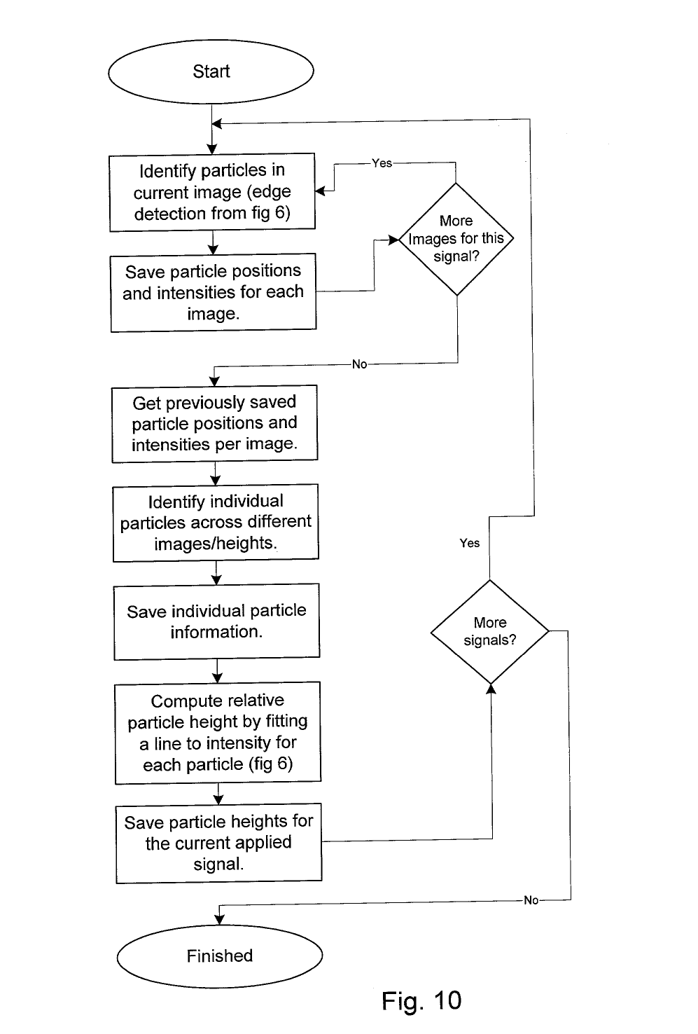

Using collected images, compute the height of each particle for each applied signal. The process by which this is done is flowcharted in FIG. 10. This process consists of the following steps: 1) identify particles in each image 2) match particles across frames 3) compute the focus height of each particle across multiple frames. The result of this is a height profile for a population of particles with different applied signals. There are many ways to display such a height profile, as exemplified by FIG. 8. The vertical axis of FIG. 8 is relative elevation. The horizontal axis is divided into a series of bands representing different applied signal frequencies. The number of cells at a particular elevation is indicated by the relative darkness of the band at that elevation. The full vertical scale for this plot is approximately 34 um. In this case, the applied signal is a 2 volt amplitude sine wave with frequencies ranging from 2 KHz up to 384 KHz. The particles for FIG. 8 are baker's yeast, prepared as described above with a conductivity of 234 uS/cm. The electrode has the electrode tip dimensions and the electrical connections shown in FIG. 3.

### ALTERNATE EMBODIMENTS OF THE INVENTION

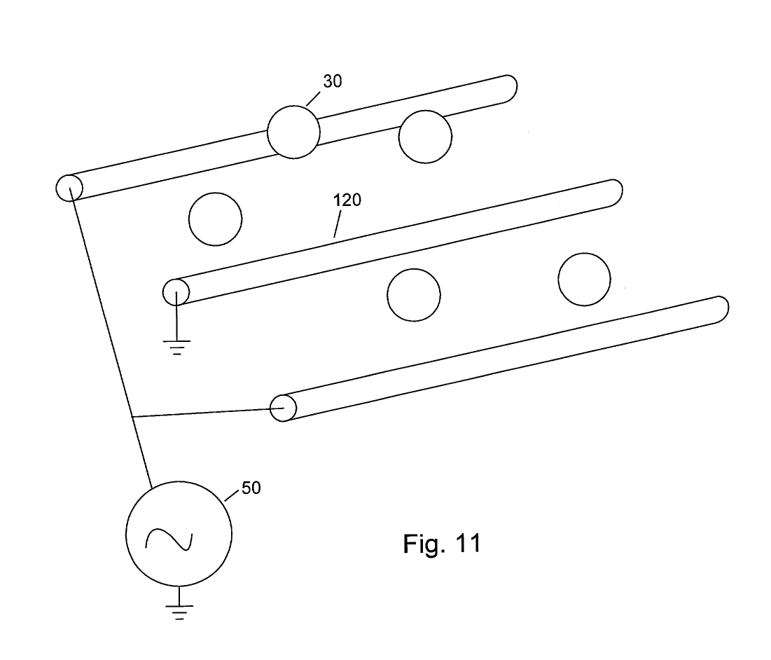

FIG. 11 shows a set of parallel wires 120 that are alternately grounded and energized with a signal from the signal generator 50. The wires serve the same function as the electrodes 32 from FIG. 2. The particles 30 are forced above and between the wires. The width of the wires and their spacing vary depending on the application.

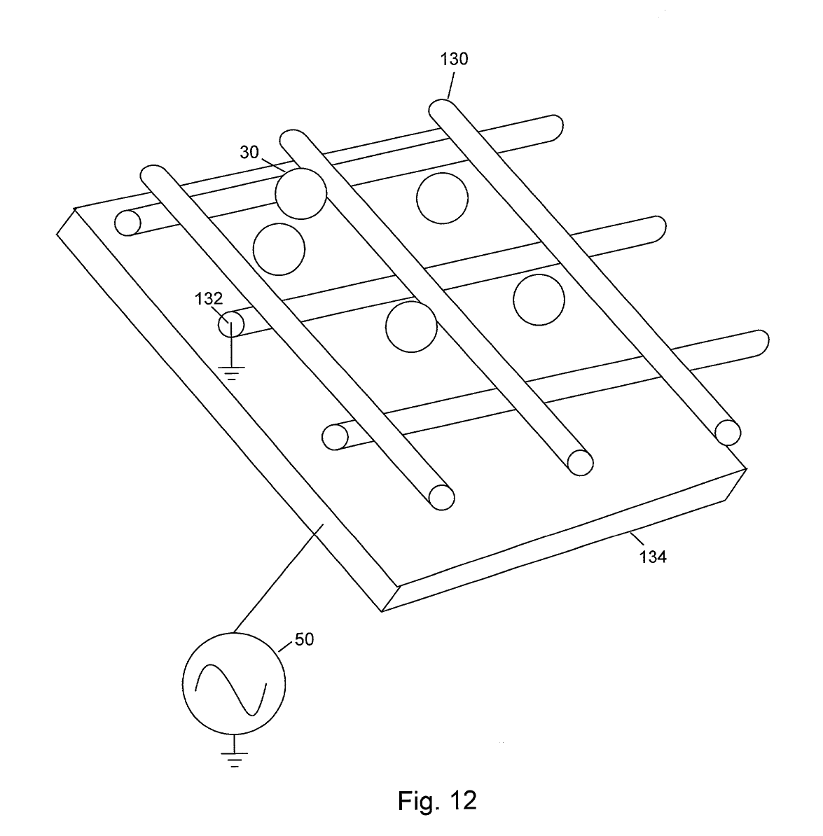

FIG. 12 shows a structure above a conductive surface 134. A signal generator 50 energizes the conductive surface. The structure 130 consists of parallel wires, crossing wires, or a mesh. The purpose of the structure is to disrupt or actively change the electric field from the base. The structure's material may or may not be electrically conductive. If the structure is electrically conductive then it may be grounded 132. If the structure is not electrically conductive, then its dielectric properties should be different than those of the surrounding fluid. Alternatively, the structure may be made of a material whose dielectric or electrical properties are adjusted dynamically. If the disrupted electric field has a non-uniform gradient then it will create dielectrophoretic forces that repel particles 30 or attract them to surfaces. Particles that are repelled become elevated over the gaps in the structure.

Consider the case from FIG. 12 where the structure actively disrupts the electric field from the base. Here it is necessary to control one or more signal generators that are connected to the structure. The means of controlling these signal generators is analogous to the means of controlling the base signal generator 50.

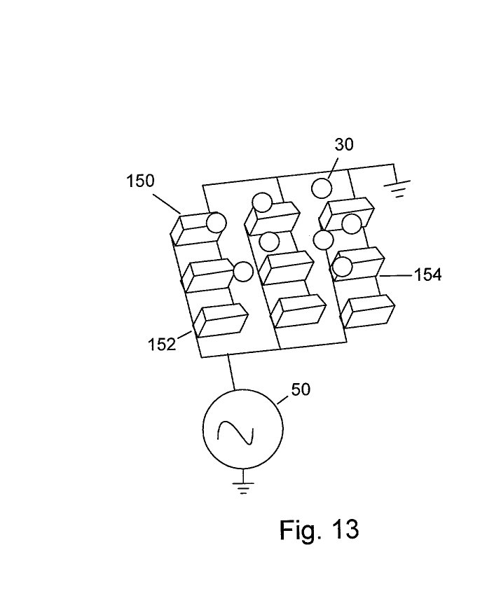

FIG. 13 shows an array of ultrasonic or acoustic or vibration elements 150 that create pressure waves in the fluid. Depending on the structural characteristics of a particle 30, it is repelled more or less strongly from the source of these pressure waves. The intensity and frequency of the pressure waves are controlled using a signal generator 50. This embodiment uses the previously described method and apparatus to control the signal generation and to determine particle elevation.

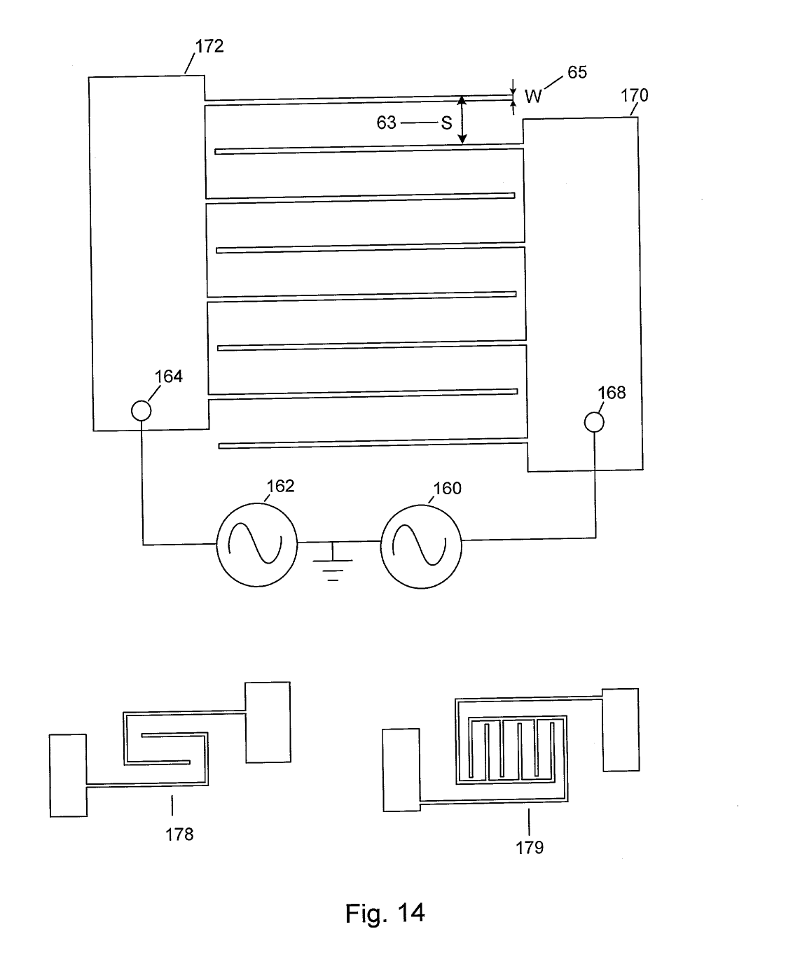

FIG. 14 shows a means of connecting multiple signal generators. In this case one signal generator 162 is connected 164 to the left electrode 172 and another signal generator 160 is connected 168 to the right electrode 170. In the case where the signal 162 and 160 are inverted reflections of one another, the effective amplitude of the signal across the electrodes is doubled. Alternatively, it is possible to use this setup to drive electrode 172 with an entirely different signal than electrode 170. Particle elevation is controlled more precisely and over a greater range by applying more than one frequency to the electrodes at one time. Also, the width 65 and the spacing 63 of the electrodes may very depending on the particular application. Finally the arrangement of the electrode array may vary in many different ways where two examples 178 and 179 are shown. An important feature of the electrode array or of any structure that distributes a signal that forces the particles up, is that this array consists of evenly spaced elements that distribute the signal over the observed area. However, it is also possible to have unevenly spaced structures that distribute signals of different amplitudes, where the different amplitudes compensate for the uneven spacing.

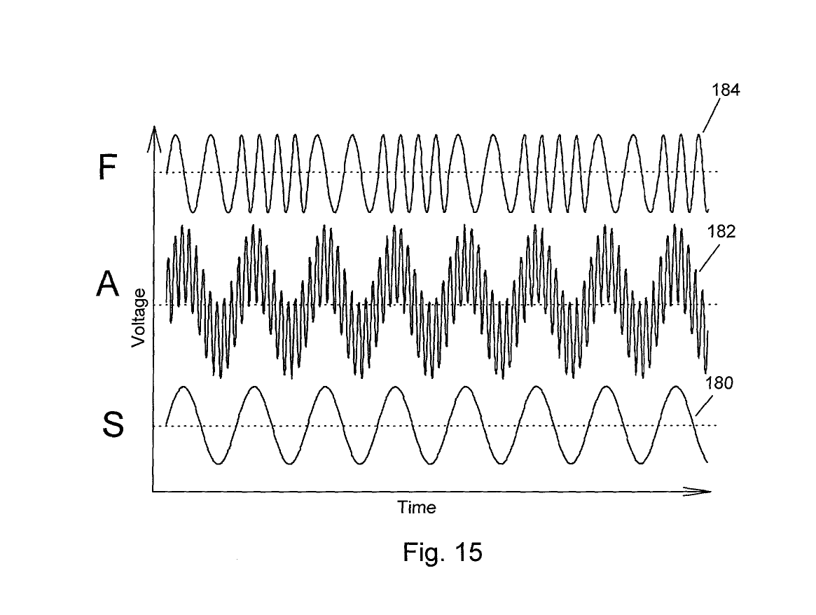

FIG. 15 shows various types of signals that might be produced by a signal generator. The horizontal axis for the plot is time and the vertical access is signal amplitude. A simple sine wave labeled S 180 is shown at the bottom. A sum of two sine waves at different frequencies labeled A 182 is shown in the middle. A frequency shift signal labeled F 184 where two frequencies occupy discrete time segments is show at the top. These are three examples of the unlimited number of possible ways to combine signals. From the perspective of the particle, it is the net amplitude of each frequency component of the signal that creates a force to move the particle. All three signals shown have a time averaged voltage of approximately zero, no DC offset. Any signal generator shown in any of the figures is a general-purpose signal generator that may produce one or more of the signal types described here.

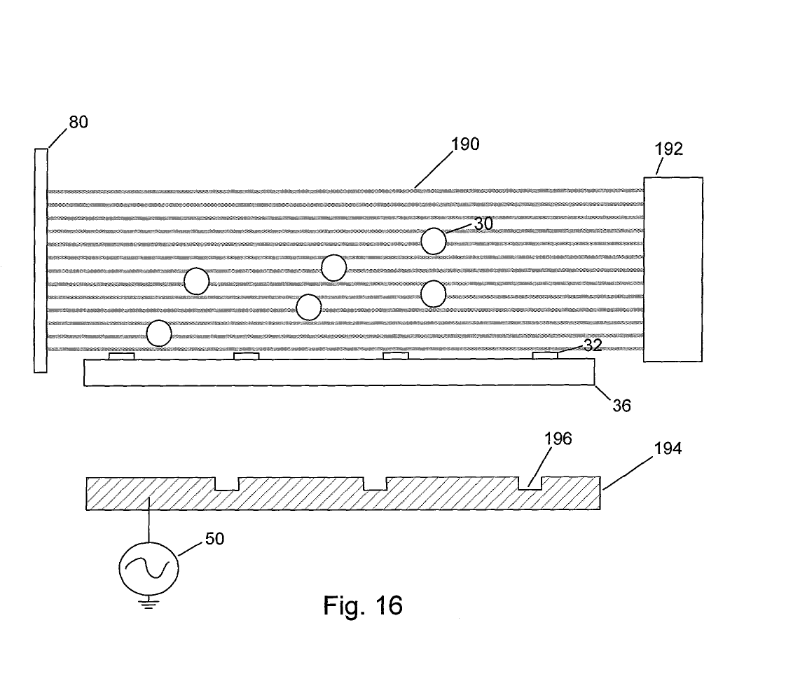

FIG. 16 shows a different approach to detecting particle 30 elevation. Here a collimated light source 192 such as a laser is positioned on one side of the chamber and pointed at the detector 80. Particles 30 are elevated over electrodes 32 on a glass substrate 36. Collimated light is diffracted by particles. Therefore, the amount of light that strikes the detector at a particular elevation is directly related to the number of particles at that elevation. Depending on the size of the chamber and the dimensions of the beam of collimated light, it may be necessary to move the light source around to cover the entire area of the detector array. However, with a lens system it should be possible to produce collimated light with wide beam width and thereby avoid the need to move the light source.

Electrical signal control for this apparatus is the same as for the preferred apparatus. This apparatus does not require a motor to control focus height and does not require a set of optics to focus light from the particles on the detector. Any of the electrodes or structures or vibration element arrays discussed elsewhere in this document may be used to levitate the particles. It is not necessary that the substrate 36 be transparent for this approach. This creates the possibility of using highly conductive (metal) plate 194 with etched grooves 196 for the base. Applying a signal 50 to such a metal plate would create electrical field gradients in the chamber and dielectrophoretic forces on the particles therein. One disadvantage of this approach is that the identities of individual particles are lost using this approach since the light that strikes the electrode may pass through more than one particle.

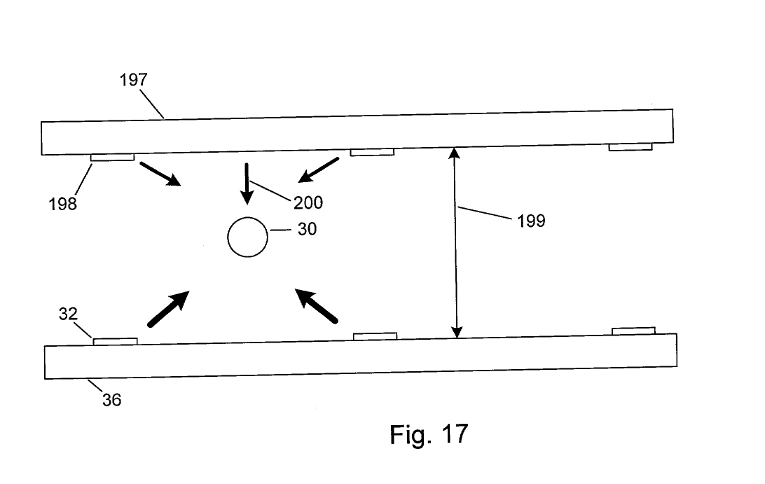

FIG. 17 shows an embodiment of the invention where an upper substrate 197 and set of electrodes 198 produce forces on a particle 30 that augment the force of gravity 200. The upper set of electrodes require their own signal generation mechanism that needs to be controlled independent of the signal generation for the bottom set of electrodes 32. The advantage of this approach is that it provides an opportunity for more control over the forces experienced by the particles. In this approach it may be useful to be able to dynamically control the distance between the two substrates 199.

### THEORY OF OPERATION

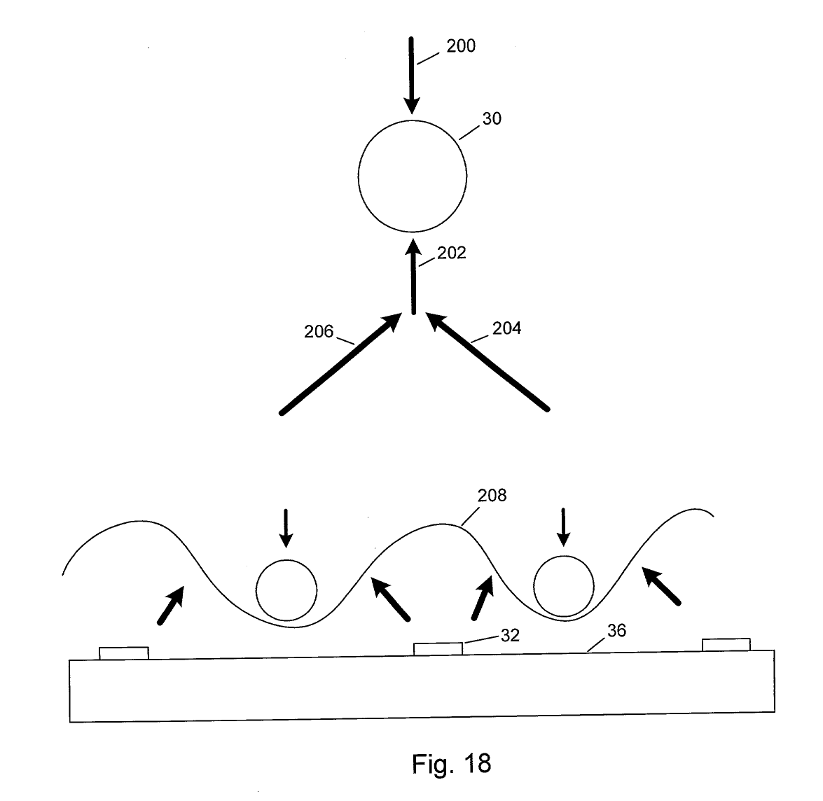

The invention works by balancing the force of gravity with an induced upward force. Particles must not be buoyant in the fluid or gas that fills the measurement chamber. Also, particles must experience a net force pushing them up when a signal is applied. FIG. 18 shows that the net vertical force 202 is the sum of other forces that have horizontal components 204, 206. The particle stops moving when all forces, including gravity 200 and the horizontal forces are balanced. Arrays of structures that repel particles create horizontally repeating force fields that trap particles in position, where they can be measured.

### CONCLUSIONS, RAMIFICATIONS AND SCOPE OF INVENTION

The invention precisely characterizes up to several hundred particles per measurement run. The apparatus may be constructed of parts that are readily purchased or are fabricated using standard techniques. The application of the invention is widespread in the case where the particles are biological cells. Other techniques employing light are currently used to measure the physical properties of biological particles; however these techniques do not measure the electrical and structural properties of biological particles directly, as does this invention.

While the above description contains many specific details, these should not be construed as limitations on the scope of the invention, but rather as examples of various embodiments of the invention. Many other variations are possible. For example, fluid and sample handling capabilities may be added to introduce particles to the chamber and to remove particles from the chamber. Alternatively, fluid handling may be added to enable the electrical or chemical properties or the fluid in the chamber to be modified. Such changes enhance the measurement capability of the system and serve to further automate the operation of the invention. To increase the productivity of the invention, it may be desirable to add multiple arrays of structures to distribute the signal. Further, it may be desirable to add multiple detectors 80 to facilitate parallel data collection. More than one computer system 48 may be used to drive the various pieces of the system or to process data as it is collected. The microscope 42 may be replaced by a customized mechanical system. The light source 52 may be either above or below the chamber 34 and the detector 80 may be either above or below the detector. The stepper motor 56 and controller may be replaced by a different kind of motor, such as a servo motor, or by another means of producing motion, such as a piezio electric actuator. Instead of moving the detector 80 lens 44 assembly, it is possible to move the chamber 34 assembly. Electrodes may be made of any conductive material not simply chrome 70 under gold 72. The substrate 36 may be any transparent or translucent material, or alternatively the substrate may be a material that emits diffuse light. The electrodes 32 may be opaque or transparent. Other techniques than the algorithm described in FIG. 7 may be used to determine when the focus plane is coincident at the center of the cell. For instance, it is possible to determine the properties of the edge of a particle image rather than the center of the particle image to determine the focus properties of a particle. The chamber walls 38 may be made of adhesive electrical tape, may be made of plastic that is affixed and patterned using photo lithographic techniques or of any other thin, low conductivity substance that will contain the contents of the chamber. When the force on the particles is from pressure waves, the walls of the chamber may be conductive. If the chamber walls are far away from the electrode area, the chamber walls may be conductive.

I claim:

1. A method for measuring the response of more than one particle to an induced force, comprising the steps of:
a. positioning more than one particle such that a net induced force acts on said particles in opposition to the downward force of gravity, and
b. measuring the equilibrium height of said particles, where the downward force of gravity is balanced by the net upward induced force,
whereby the response of said particles to the induced force is measured.

2. The method of claim 1 wherein said induced force on said particles is caused by dielectrophoresis.

3. The method of claim 1 wherein said induced force on said particles is caused by pressure waves.

4. The method of claim 1 wherein the measurement of said height of said particles is made by analyzing images of said particles taken from various elevations above or below said particles.

5. The method of claim 1 wherein the measurement of said height of said particles is made by analyzing images of said particles taken from the side.

6. The method of claim 1 wherein the downward force of gravity is augmented by an induced downward force.

7. A measurement device, comprising:
a. a means of creating an induced force on a set of more than one particle, said force having a net upward component when applied to said particles,
b. a means for measuring the height of said particles while said force is applied in opposition to the force of gravity,
whereby the response of said particles to the induced force is measured.

8. The measurement device of claim 7 wherein the means of creating said induced force on said particles is an arrangement of electrically conductive structures with an induced time varying voltage.

9. The measurement device of claim 7 wherein the means of creating said induced force on said particles is an arrangement of structures with an induced vibration.

10. The measurement device of claim 7 wherein the means of measuring said height of said particles consists of a top or bottom mounted image detector which is moved vertically relative to the elevation of said particles.

11. The measurement device of claim 7 wherein the means of measuring said height of said particles consists of a side mounted image detector.

12. The measurement device of claim 7 wherein the force of gravity is augmented by a means of creating a net downward force on said particles.

13. A method for measuring the positions of one or more particles, comprising the steps of:
a. positioning an image detector at various positions relative to the position of said particles, and
b. capturing images of said particles at said positions, and
c. analyzing differences among said images,
whereby the relative positions of said particles are measured.

14. The method of claim 13 wherein said analysis comprises the steps of:
a. determining the position of each particle within each image, and
b. determining the image intensity of each particle within each image, and
c. computing the change in intensity of each particle within each image.
